(19) United States
(12) Patent Application Publication
(10) Pub. No.: US 2020/0362909 A1
(43) Pub. Date: Nov. 19, 2020

(54) POSITIONING BRACKET METHOD THROUGH SUCTION CUP AND SUCTION CUP THEREOF

(71) Applicant: FERRO-CARBON ENTERPRISE CO., LTD., Taichung City (TW)

(72) Inventor: Lung-Chih CHEN, Taichung City (TW)

(21) Appl. No.: 16/841,697

(22) Filed: Apr. 7, 2020

(30) Foreign Application Priority Data
May 15, 2019 (TW) 108116782

(51) Int. Cl. F16B 47/00; F16M 13/02; A47B 95/00; A47B 57/32

(52) U.S. Cl. CPC F16B 47/006; A47B 57/32; A47B 95/008; F16M 13/022

(57) ABSTRACT

A positioning bracket method through suction cup includes a bracket providing step, a suction cup providing step and a bracket positioning step. In the bracket providing step, at least one bracket is provided, and one end of the bracket is abutted against a plane. In the suction cup providing step, at least one suction cup is provided, wherein the suction cup includes at least one positioning groove. In the bracket positioning step, the at least one positioning groove of the at least one suction cup is disposed on the at least one bracket along a central axis thereof, and the at least one suction cup is attached to another plane perpendicular to the plane, so as to position the bracket by the suction cup and the planes.

### RELATED APPLICATIONS

This application claims priority to Taiwan Application Serial Number 108116782, filed May 15, 2019, which is herein incorporated by reference.

### BACKGROUND

### Technical Field

The present disclosure relates to a positioning bracket method. More particularly, the present disclosure relates to a positioning bracket method through suction cup and a suction cup thereof.

### Description of Related Art

In daily life, it is common to see that extra brackets are added on the walls of shopping malls to get more storage space. The brackets are usually nailed into the walls by the common fixings, such as screws, nails, etc., so as to achieve the purpose of positioning the brackets. However, this method is not only time-consuming and laborious, but also damages the internal structure of the wall. Over a long time, the cracks of the wall may spread and affect the beauty of the wall. Further, if the brackets are removed in the future, the marks of the fixing holes will be left on the wall, and it should be repaired to restore to the original state. The traditional positioning bracket method is inconvenient and should be improved. Therefore, it is necessary to develop another convenient fixing method to improve the above problem, which is the primary problem to be solved by the present disclosure.

### SUMMARY

According to one aspect of the present disclosure, a positioning bracket method through suction cup includes a bracket providing step, a suction cup providing step and a bracket positioning step. In the bracket providing step, at least one bracket is provided, and one end of the bracket is abutted against a plane. In the suction cup providing step, at least one suction cup is provided, the suction cup includes at least one positioning groove. In the bracket positioning step, the at least one positioning groove of the at least one suction cup is disposed on the at least one bracket along a central axis thereof, and the at least one suction cup is attached to another plane perpendicular to the plane, so as to position the bracket by the suction cup and the planes.

According to another aspect of the present disclosure, a suction cup applied to the positioning bracket method through the suction cup according to the aforementioned aspect includes a body, an attaching element, an operating portion and two positioning grooves. The body has a first side and a second side. The attaching element is connected to the first side of the body. The operating portion is pivotally connected to the second side of the body, and for linking the attaching element. The two positioning grooves are disposed on the first side of the body and extending directions of the two positioning grooves are perpendicular to each other.

### BRIEF DESCRIPTION OF THE DRAWINGS

The present disclosure can be more fully understood by reading the following detailed description of the embodiment, with reference made to the accompanying drawings as follows:

FIG. 1 is a block diagram of a positioning bracket method through suction cup according to the 1st embodiment of the present disclosure.

FIG. 2 is a schematic view of the suction cup positioning the bracket according to the 1st embodiment of FIG. 1.

FIG. 3 is a three-dimensional schematic view of the suction cup according to the 1st embodiment of FIG. 1.

FIG. 4 is a side view of the suction cup according to the 1st embodiment of FIG. 1.

FIG. 5 is a three-dimensional schematic view of a suction cup applied to a positioning bracket method through suction cup according to the 2nd embodiment of the present disclosure.

FIG. 6 is a schematic view of the suction cup and a bracket according to the 2nd embodiment of FIG. 5.

FIG. 7 is a schematic view of suction cups and brackets of a positioning bracket method through suction cup according to the 3rd embodiment of the present disclosure.

### DETAILED DESCRIPTION

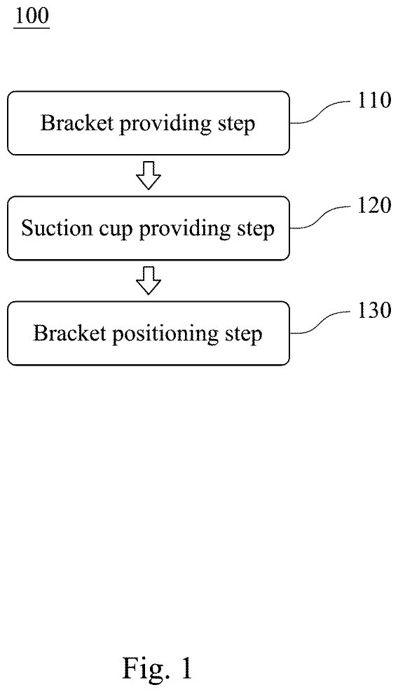

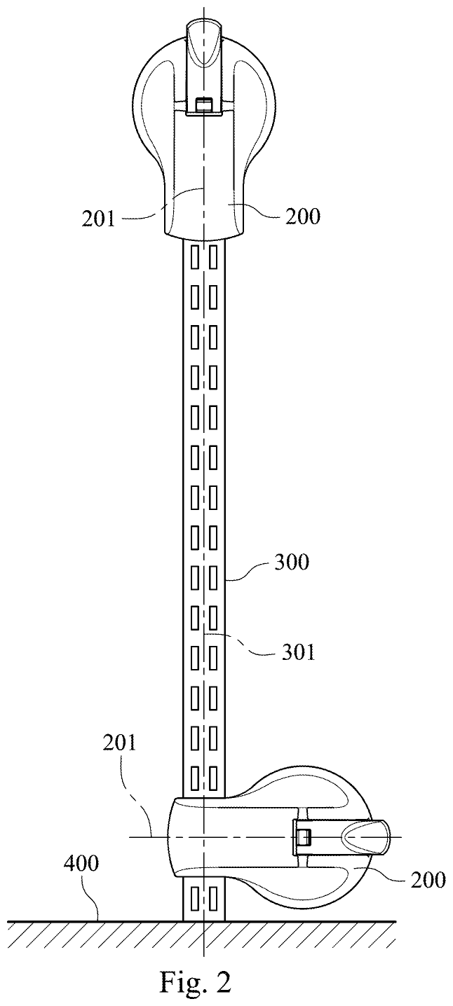

FIG. 1 is a block diagram of a positioning bracket method through suction cup 100 according to the 1st embodiment of the present disclosure. FIG. 2 is a schematic view of the suction cup 200 positioning the bracket 300 according to the 1st embodiment of FIG. 1. As shown on FIGS. 1 and 2, the positioning bracket method through the suction cup 100 includes a bracket providing step 110, a suction cup providing step 120 and a bracket positioning step 130.

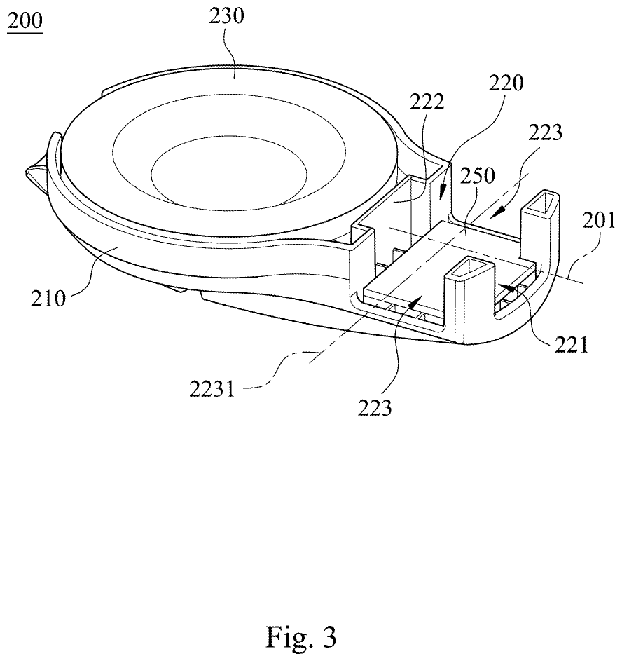

In the bracket providing step 110, at least one bracket 300 is provided, and one end of the bracket 300 is abutted against a plane 400. In the suction cup providing step 120, at least one suction cup 200 is provided, and the suction cup 200 includes at least one positioning groove 220 (please refer to FIG. 3). In the bracket positioning step 130, the at least one positioning groove 220 of the at least one suction cup 200 is disposed on the at least one bracket 300 along a central axis 301 thereof, and the at least one suction cup 200 is attached to another plane (its reference numeral is omitted) perpendicular to the plane 400, so as to position the bracket 300 by the suction cup 200 and the planes. Therefore, as shown in FIG. 2, the bracket 300 can be abutted against and positioned on the plane 400 stably via the suction cup 200 by the positioning bracket method through the suction cup 100.

Specifically, the bracket 300 provided in the bracket providing step 110 can be a flag-shaped bracket or a detachable cabinet assembled by a plurality of brackets, which is generally used in exhibitions or shopping malls. Such applications are usually temporary disposed, which are not suitable for positioning on the ground or wall by nailing or sticking. Thus, in the bracket providing step 110, after the bracket 300 is provided, one end of the bracket 300 is positioned and abutted against the plane 400 which the bracket 300 will be positioned on, such as a ground or a wall. Then with the suction cup 200 provided in the suction cup providing step 120, the positioning groove 220 of the suction cup 200 is disposed on the bracket 300 along the central axis 301 thereof. Since the suction cup 200 is detachably attached to another plane, the bracket 300 can be positioned at a predetermined position, and the position can be removed or changed at any time as required. Further, the end of the bracket 300 abutted against the plane 400 can provide a supporting force and is suitable for being assembled with other brackets to form a table or a shelf so as to provide the function of arranging items.

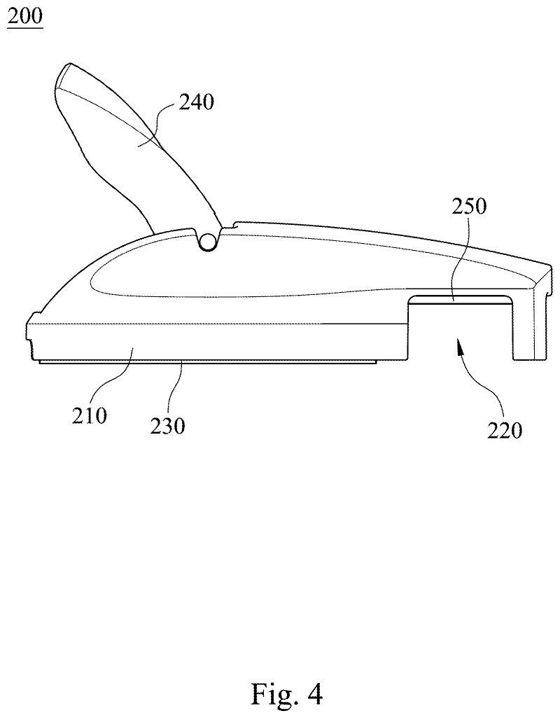

FIG. 3 is a three-dimensional schematic view of the suction cup 200 according to the 1st embodiment of FIG. 1. FIG. 4 is a side view of the suction cup 200 according to the 1st embodiment of FIG. 1. In the 1st embodiment, the suction cup 200 provided in the suction cup providing step 120 can include a body 210, an attaching element 230, an operating portion 240 and at least one positioning groove 220.

In detail, the body 210 has a first side (its reference numeral is omitted) and a second side (its reference numeral is omitted), the attaching element 230 is connected to the first side of the body 210 of the suction cup 200, the positioning grooves 220 are disposed on the first side of the body 210 (that is, the same side as the attaching element 230 connected to), and the operating portion 240 is pivotally connected to the second side of the body 210 and for linking the attaching element 230. Therefore, after the suction cup 200 is disposed on the bracket 300 with the positioning groove 220, the suction cup 200 can connected the predetermined plane by the attaching element 230. When the user wants to change the positioned position of the bracket 300, the attaching element 230 can be linked with the operating portion 240 to disconnect the suction cup 200 from the plane.

As shown in FIG. 3, a number of the positioning grooves 220 is two, one of the positioning grooves 220 can have two connecting openings 223, the other one of the positioning grooves 220 can have a connecting opening 221 and an abutting wall 222. In detail, in the 1st embodiment of FIG. 3, an extending direction 2231 of one of the positioning grooves 220 is perpendicular to a central axis 201 of the suction cup 200, the two connecting openings 223 are oppositely disposed along a direction perpendicular to the central axis 201 (that is, the extending direction 2231). The extending direction (its reference numeral is omitted) of the other one of the positioning grooves 220 is parallel to the central axis 201 of the suction cup 200. The abutting wall 222 and the connecting opening 221 are oppositely disposed along a direction parallel to the central axis 201, and the abutting wall 222 can be a U-shape. The two positioning grooves 220 overlap with each other in a cross shape, that is, the extending directions of the two positioning grooves 220 are perpendicular to each other. As shown in FIGS. 2 and 3, the number of the suction cups 200 provided in the suction cup providing step 120 can be two. In the bracket positioning step 130, the positioning grooves 220 of one of the suction cups 200 are disposed on the other end of the bracket 300 along the central axis 301 parallel to the bracket 300, and the other suction cups 200 is disposed on the central axis 301 of the bracket 300 and is close to the plane 400. Therefore, after the other end of the bracket 300 is abutted against the abutting wall 222 of the positioning grooves 220, the attaching elements 230 are connected to the predetermined plane, and the attaching element 230 can position the bracket 300 more stably via the U-shape of the abutting wall 222.

In order to expand the application range of the suction cup 200 so as to be suitable for using with different sizes of the brackets, the suction cup 200 can further include a pad 250, which is disposed on a bottom (its reference numeral is omitted) of the positioning grooves 220. When the user wants to position the suction cup 200 to a bracket with a small tube diameter, the pad 250 can reduce the space of the positioning grooves 220, the suction cup 200 can be stably connected to the bracket with the small tube diameter, so that the stability of positioning the bracket can be increased. Further, the pad 250 can be fixedly or detachably disposed in the positioning grooves 220, and the pad 250 can be made of a compressible material, which is more suitable for using with the brackets of different sizes.

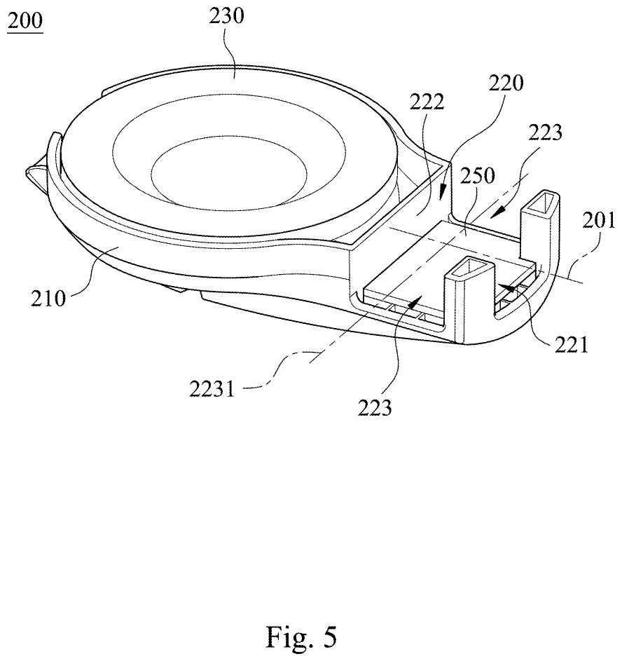

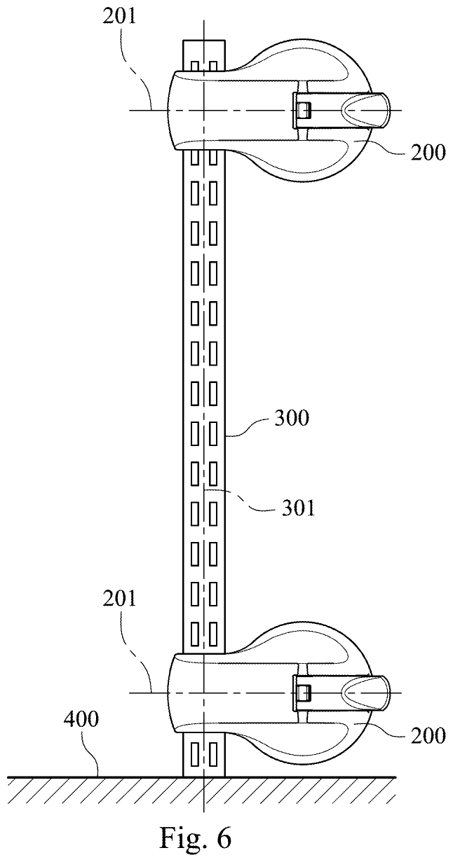

FIG. 5 is a three-dimensional schematic view of a suction cup 200 applied to a positioning bracket method through suction cup 100 according to the 2nd embodiment of the present disclosure. FIG. 6 is a schematic view of the suction cup 200 and a bracket 300 according to the 2nd embodiment of FIG. 5. The arrangements of the body 210, the attaching element 230, the operating portion 240 and the two positioning grooves 220 of the suction cup 200 in the 2nd embodiment of FIG. 5 are the same as the corresponding components in the 1st embodiment of FIG. 3, and will not described again herein. In FIG. 5, the positioning grooves 220 overlap each other in a T shape, wherein the abutting wall 222 of one of the positioning grooves 220 is a flat surface. The bracket providing step 110 and the suction cup providing step 120 in the 2nd embodiment of FIG. 6 are the same as the corresponding steps in the 1st embodiment of FIG. 1, and will not described again herein. In detail, in the bracket positioning step 130, the positioning grooves 220 of the two suction cups 200 are disposed on the bracket 300 along the central axis 301 thereof, the central axes 201 of the two suction cups 200 are both perpendicular to the central axis 301 of the bracket 300, one of the suction cups 200 is disposed on the other end of the bracket 300, and the other one of the suction cups 200 is disposed on the bracket 300 and is close to the plane 400. Therefore, the position of the suction cups 200 connected to the plane can be adjusted according to the relative positional relationship between the bracket 300 and different planes, so as to expand the application range of the positioning bracket method through the suction cup 100.

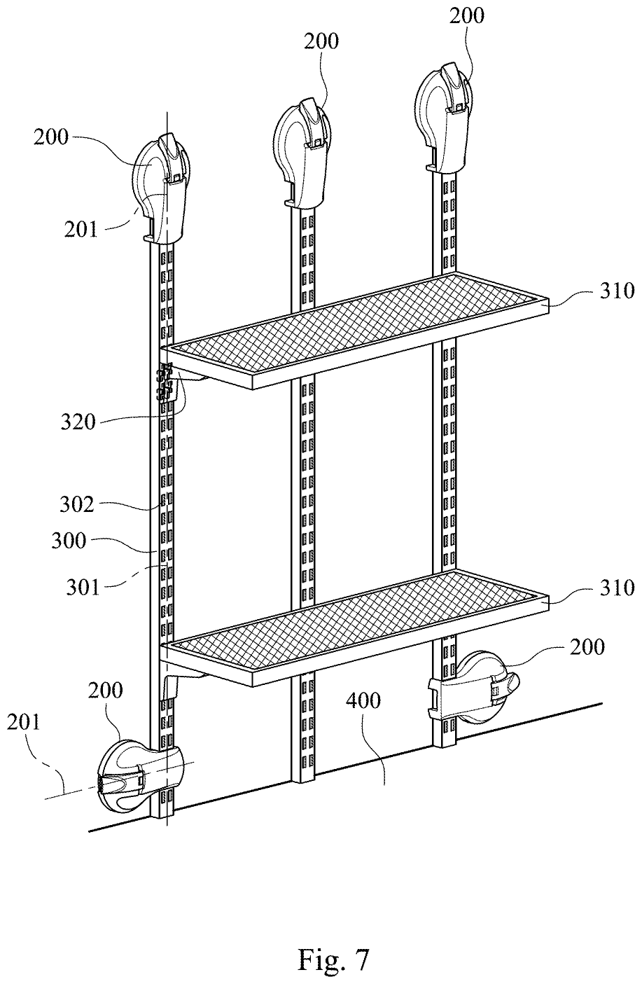

FIG. 7 is a schematic view of suction cups 200 and brackets 300 of a positioning bracket method through suction cup 100 according to the 3rd embodiment of the present disclosure. In the 3rd embodiment of FIG. 7, the bracket providing step 110, the suction cup providing step 120 and the bracket positioning step 130 of the positioning bracket method through the suction cup 100 are the same as the corresponding steps in FIG. 1, and will not described again herein. Especially, in the 3rd embodiment of FIG. 7, the number of the brackets 300 provided in the bracket providing step 110 can be plural, and the number of the suction cups 200 provided in the suction cup providing step 120 can be plural. In detail, the plurality of brackets 300 in the 3rd embodiment can have a plurality of assembling holes 302, the hooks 320 of the shelf boards 310 can be connected to the assembling holes 302 so as to connect and assemble the plurality of brackets 300 with each other to form a detachable cabinet or a table (not shown) for displaying items. With the suction cups 200 provided in the suction cup providing step 120, in the bracket positioning step 130, the positioning grooves 220 of the suction cups 200 are disposed on the brackets 300 along the central axis 301 thereof. Since the suction cups 200 are detachably attached to another plane, the cabinet or the table formed by the plurality of brackets 300 can be positioned at a predetermined position, and the position can be disassembled or changed at any time as required. Further, in the 3rd embodiment, the bracket positioning step 130 can be the bracket positioning step 130 shown as FIG. 2 and FIG. 6, the central axes 201 of the suction cups 200 can be selectively connected to the central axis 301 of the brackets 300 in parallel or perpendicular. Therefore, by positioning the plurality of brackets 300 via the plurality of suction cups 200, the detachable cabinet or the table can be positioned more stably, and the connection direction of each suction cups 200 and the bracket 300 can be adjusted adaptively, which is favorable for changing the positioning manner of the suction cups 200 according to different environments.

It should be mentioned that the positioning bracket method through suction cup of the present disclosure will not be limited to the brackets and the suction cups described and illustrated herein.

With the aforementioned embodiments, the positioning bracket method through suction cup according to the present disclosure has the following advantages: first, by the positioning bracket method through suction cup according to the present disclosure, the brackets are abutted against the plane, and the suction cups connected to the brackets are detachably attached to another plane, so that the stability of the positioning of the brackets can be improved, and the purpose of positioning the bracket in a detachable manner can be achieved. Second, the cabinet and the table assembled by the plurality of the brackets can be positioned by one or multiple suction cups, and it not only can provide the function of setting items in the exhibition or shopping mall but also can be changed or disconnected their position at any time as required. Third, the suction cups can have a pad which can be made of a compressible or detachable material, the suction cups can be connected to the brackets with different tube diameters and can be suitable for using with the brackets of different sizes, so as to expand the application range of the suction cups of the positioning bracket method through suction cup.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A positioning bracket method through suction cup, comprising:
a bracket providing step, wherein at least one bracket is provided, and one end of the bracket is abutted against a plane;
a suction cup providing step, wherein at least one suction cup is provided, the suction cup comprises at least one positioning groove; and
a bracket positioning step, wherein the at least one positioning groove of the at least one suction cup is disposed on the at least one bracket along a central axis thereof, and the at least one suction cup is attached to another plane perpendicular to the plane, so as to position the bracket by the suction cup and the planes.

2. The positioning bracket method through the suction cup of claim 1, wherein an extending direction of the at least one positioning groove is parallel to a central axis of the suction cup, thus in the bracket positioning step, the at least one suction cup is disposed on the at least one bracket, and the central axis of the at least one suction cup is parallel to the central axis of the at least one bracket.

3. The positioning bracket method through the suction cup of claim 1, wherein an extending direction of the at least one positioning groove is perpendicular to a central axis of the suction cup, thus in the bracket positioning step, the at least one suction cup is disposed on the at least one bracket, and the central axis of the at least one suction cup is perpendicular to the central axis of the at least one bracket.

4. The positioning bracket method through the suction cup of claim 1, wherein a number of the at least one positioning groove of the at least one suction cup is two, an extending direction of one of the positioning grooves is parallel to a central axis of the suction cup, an extending direction of the other one of the positioning grooves is perpendicular to the central axis of the suction cup, thus in the bracket positioning step, one of the positioning grooves is disposed on the at least one bracket along the central axis thereof, and the central axis of the at least one suction cup is parallel or perpendicular to the central axis of the at least one bracket.

5. The positioning bracket method through the suction cup of claim 1, wherein a number of the at least one suction cup provided in the suction cup providing step is two, in the bracket positioning step, the at least one positioning groove of each of the suction cups is disposed on the at least one bracket along the central axis thereof, and the at least one suction cups are attached to the other plane so as to position the bracket, an extending direction of the at least one positioning groove of one of the suction cups is parallel or perpendicular to an extending direction of at least one positioning groove of another one of the suction cups.

6. The positioning bracket method through the suction cup of claim 5, wherein the at least one positioning groove of one of the suction cups is disposed on the other end of the bracket along the central axis of the at least one bracket, and the at least one positioning groove of the other one of the suction cups is disposed on the at least one bracket along the central axis thereof and is close to the plane.

7. The positioning bracket method through the suction cup of claim 1, wherein a number of the at least one bracket provided in the bracket providing step is plural, the brackets are assembled and connected to each other.

8. A suction cup applied to the positioning bracket method through the suction cup of claim 1, comprising:
a body having a first side and a second side;
an attaching element connected to the first side of the body;
an operating portion pivotally connected to the second side of the body, and for linking the attaching element; and
two positioning grooves disposed on the first side of the body and extending directions of the two positioning grooves are perpendicular to each other.

9. The suction cup of claim 8, further comprising:
a pad disposed on a bottom of at least one of the positioning grooves.

10. The suction cup of claim 8, wherein at least one of the positioning grooves has two connecting openings oppositely disposed along the extending direction of the at least one of the positioning grooves.

11. The suction cup of claim 8, wherein at least one of the positioning grooves has a connecting opening and an abutting wall, and the connecting opening and the abutting wall are oppositely disposed along the extending direction of the at least one of the positioning grooves.
